(19) United States
(12) Patent Application Publication
(10) Pub. No.: US 2018/0002200 A1
(43) Pub. Date: Jan. 4, 2018

(54) Method and Apparatus for the Mass Production and Absorption of Oyxgen into Seawater

(71) Applicant: Ron Mehl, Cartersville, GA (US)

(72) Inventor: Ron Mehl, Cartersville, GA (US)

(21) Appl. No.: 15/640,426

(22) Filed: Jun. 30, 2017

Related U.S. Application Data
(60) Provisional application No. 62/357,934, filed on Jul. 1, 2016.

(51) Int. Cl. C02F 1/467; H01M 6/34; C25B 1/04; C02F 103/08

(52) U.S. Cl. CPC C02F 1/4672; C25B 1/04; H01M 6/34; C02F 2201/009; C02F 2103/08; C02F 2201/46105

(57) ABSTRACT

The system is one in which submerged electrolytic cells provide electricity from the seawater, that directly energizes electro-chemical cells that produce oxygen and hydrogen. The entire system is configured so that micro bubbles of oxygen are quickly adsorbed as they rise toward the surface, increasing dissolved oxidation (DO) by adsorption into the water.

### CROSS REFERENCE TO RELATED APPLICATIONS

Claims the benefit of provisional application No. 62/357,934 filed on Jul. 1,2016.

### REFERENCE TO GOVERNMENT FUNDING SOURCES

Not applicable.

### REFERENCE TO SEQUENCE LISTING

Not applicable.

### FIELDS OF THE INVENTION

The disclosure as detailed herein is in the technical field of industrial systems. More specifically, the present disclosure relates to the technical field of electrochemical production of electricity. Even more specifically, the present disclosure relates to the technical field of electrolytic oxidation.

### DESCRIPTION OF RELATED ART

Hypoxia occurs when the oxygen required to support life becomes depleted, which can result in severe impairment of near-shore fisheries. Consequently, dead zones can also destabilize the businesses, families and communities that are sustained by fisheries. Further, nutrient enrichment can jeopardize the future of estuaries and coastal wetlands that depend on freshwater and sediment delivery for stability and persistence. In short, clean water is critical to the ecological, cultural and economic well-being of the world.

### GENERAL SUMMARY OF THE INVENTION

The system is one in which submerged electrolytic cells provide electricity from the seawater, that directly energizes electro-chemical cells that produce oxygen and hydrogen. The entire system is configured so that micro bubbles of oxygen are quickly adsorbed as they rise toward the surface, increasing dissolved oxidation (DO) by adsorption into the water.

Electricity, hydrogen and oxidation are generated from sea water through a unique electrolytic process and cell design. In this case, the seawater and its currents (movement) are the sole source of generating the electricity that in turn generates the oxygen needed to solve the problems associated with hypoxia. In practice, large underwater platforms consisting of hundreds or thousands of “electrolytic cells” generate electricity through electrolysis that in turn delivers power to a second set of “electrolytic cells” that generate oxygen. The process is self contained and continuous without the need of outside influences.

The natural movement of the ocean currents moves the water through the cells to produce electricity, while the unlimited source salt water provides the ideal electrolyte. The problem areas in our oceans are call “Dead Zones” which can be as small as one hundred square feet to as large as several thousand square feet in area. The localized treatments of these “Dead Zones” eliminate the need to treat the “whole ocean” to solve a localized problem. The system incorporates the fabrication of low cost cells linked together to cover a large area over “dead zones” where the oxygen depleted water passes through the “platform of cells” and where oxygen is generated at the anode surface of each cell.

In reality each cell produces oxygen and hydrogen of very small (micro) bubbles, as these bubbles rise toward the surface the oxygen bubbles are adsorbed into the water increasing the dissolved oxygen (DO) levels. The bubbles of hydrogen continue to rise with fewer and fewer oxygen bubbles in the “cloud”. At some point the oxygen has all been adsorbed leaving only the hydrogen to reach the surface where it is collected and stored. In some embodiments this system generate electricity, oxygen and hydrogen from seawater. In some embodiments this system may produce an electrolytic cell produces oxygen in mass. In some embodiments the system may increase the adsorption rate of Oxygen into water. In some embodiments there is a system to dissolve 100% of the oxygen produced into seawater. In some embodiments the system may generate and collect Hydrogen. In some embodiments the system may generate “micro-bubbles” of oxygen. In some embodiments the system may be comprised of individual cells linked together to cover large areas. In some embodiments the system generates its own operating power from seawater In some embodiments the system can be expanded by the addition of “cell units”. In some embodiments the system may generate electricity from seawater. In some embodiments the system may use seawater to power electrolytic cells to generate free oxygen and hydrogen. In some embodiments the system may enable the natural separation of Oxygen and Hydrogen in water Some embodiments may include a uniform cell design that can change its function by changes in electrode materials. In some embodiments the system may include Electrolytic Cells that can be “snapped” together to form “platforms” that cover large areas. In some embodiments the system may produce Micro Bubble of oxygen and hydrogen. In some embodiments the system may be operational 24 hours a day 7-days a week In some embodiments the system includes an electrolytic system of cells that can be completely submerged. In some embodiments the system can be moved in order to target areas of most need. In some embodiments the system may be stabilized by tension from surface hydrogen filled containers. In some embodiments the system may be positioned using GPS technologies In some embodiments the system may capture and utilize hydrogen. In some embodiments the system may increase the absorption rate of oxygen.

### DESCRIPTION OF FIGURES

FIG. 1 is a diagram view which shows overall use of the system.

FIG. 2 is a diagram view which shows placing the OPS in the depleted salt water region.

FIG. 3 is a diagram view which shows the generation of electricity in the OPS.

FIG. 4 is a diagram view which shows the generation of H2 and O2 in the

OPS.

FIG. 5 is a perspective view which shows an embodiment of the OPS.

FIG. 6 is a perspective view which shows buoyancy capture device and cables.

FIG. 7 is a perspective view which shows the OPS monitoring system on the buoyancy capture device.

FIG. 8 is a perspective view which shows the ec cell array.

FIG. 9 is a perspective view which shows the inserts on the surface of the ec cell.

FIG. 10 is a perspective view which shows the receptors on the surface of the ec cell.

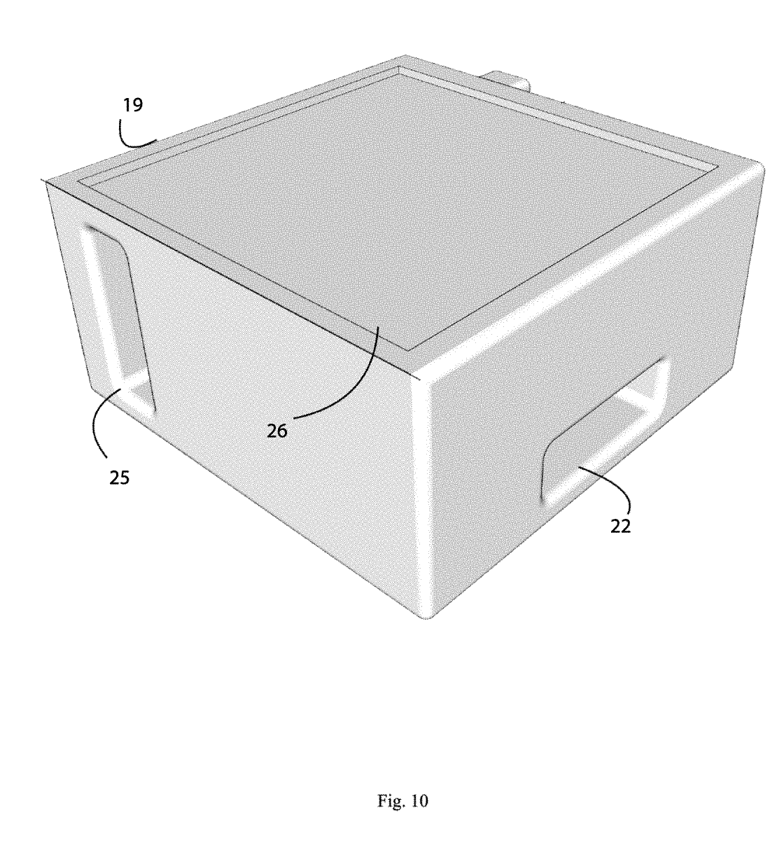

FIG. 11 is a perspective view which shows the e cell array.

FIG. 12 is a perspective view which shows an embodiment of a connection device and power transmission cables.

FIG. 13 is a perspective view which shows the lower platform/upper platform distance.

FIG. 14 is a perspective view which shows embodiment of the OPS using anchors for the OPS positioning system.

FIG. 15 is a perspective view which shows the e cell functional group.

FIG. 16 is a perspective view which shows the inserts on the surface of the e cell.

FIG. 17 is a perspective view which shows the receptors on the surface of the e cell.

FIG. 18 is a perspective view which shows an embodiment of the upper platform where the ec cells have variable size.

### DETAILED DESCRIPTION

Mass oxygen evolution (accelerated electro-chemical oxidation) can be achieved by a duel system of electrolytic cells, mounted in a platform configurations, below the surface of the water, in which electricity generated in the lower platform energizes the electrochemical cell that produce oxygen and hydrogen. The micro bubbles of oxygen and hydrogen leave the cells and travel toward the surface. Due to the micron size of these bubbles the oxygen is adsorbed by the water very quickly, leaving the free hydrogen to continue to the surface to be captured and stored.

A preferred embodiment of the present invention is now described with reference to the figures, where like reference numbers indicate identical or functionally similar elements. Also in the figures, the leftmost digit of each reference number corresponds to the figure in which the reference number is first used. While specific configurations and arrangements are discussed, it should be understood that this is done for illustrative purposes only. A person of ordinary skill in the relevant art will recognize that other configurations and arrangements can be used without departing from the spirit and scope of the invention. It will be apparent to a person of ordinary skill in the relevant art that this invention can also be employed in a variety of other systems and applications.

The instance invention has some elements that are commonly known and also terms defined for the purposes of this specification including: ec generated micro bubbles 35, an oxygen depleted salt water region 36, an effective O2 absorption distance, an ops transport vehicle, and finally a minimum effective voltage 39. Their use and relationships to the novel components and steps of the invention render them applicable herein.

The term minimum effective voltage 39 comprises the amount of voltage required to generate enough current in ec cells to produce oxygen and hydrogen.

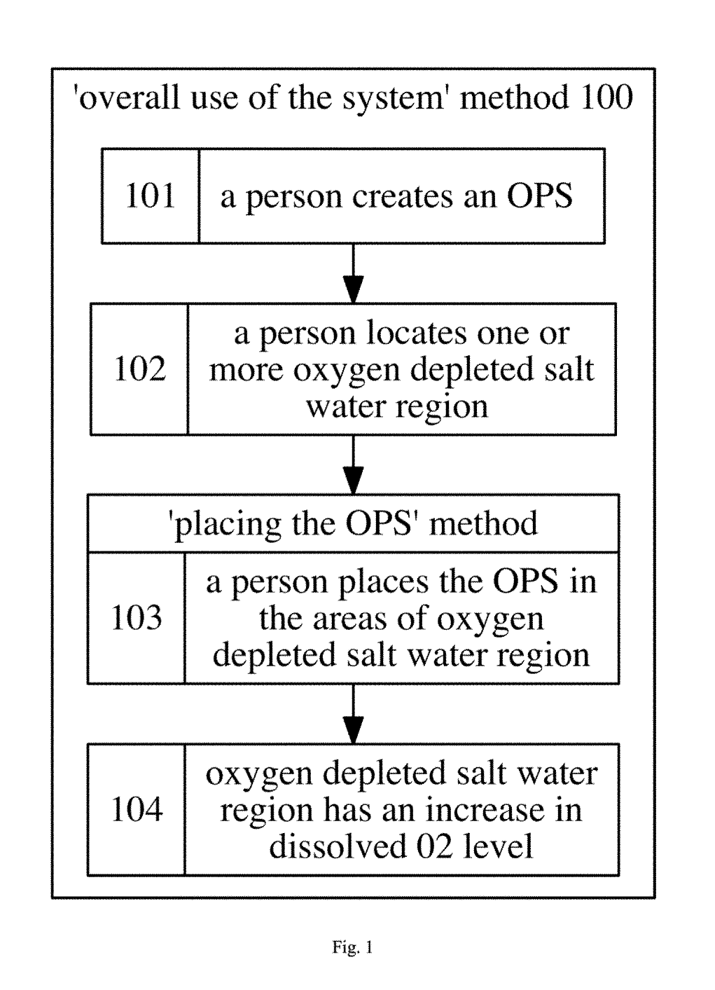

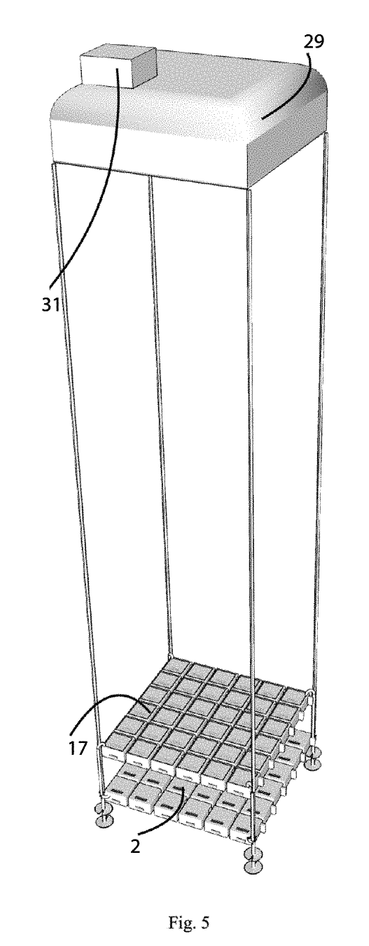

The invention is used as follows: (FIG. 1) First, one or more persons creates or otherwise obtains an OPS 1. The OPS 1 comprises a system that produces large amounts of oxygen through electrolytic means. The OPS 1 (FIG. 5) preferably comprises a lower platform 2, a lower platform/upper platform distance 14, a connection device 15, an upper platform 17, buoyancy cables, a buoyancy capture device 29, and finally an OPS positioning system.

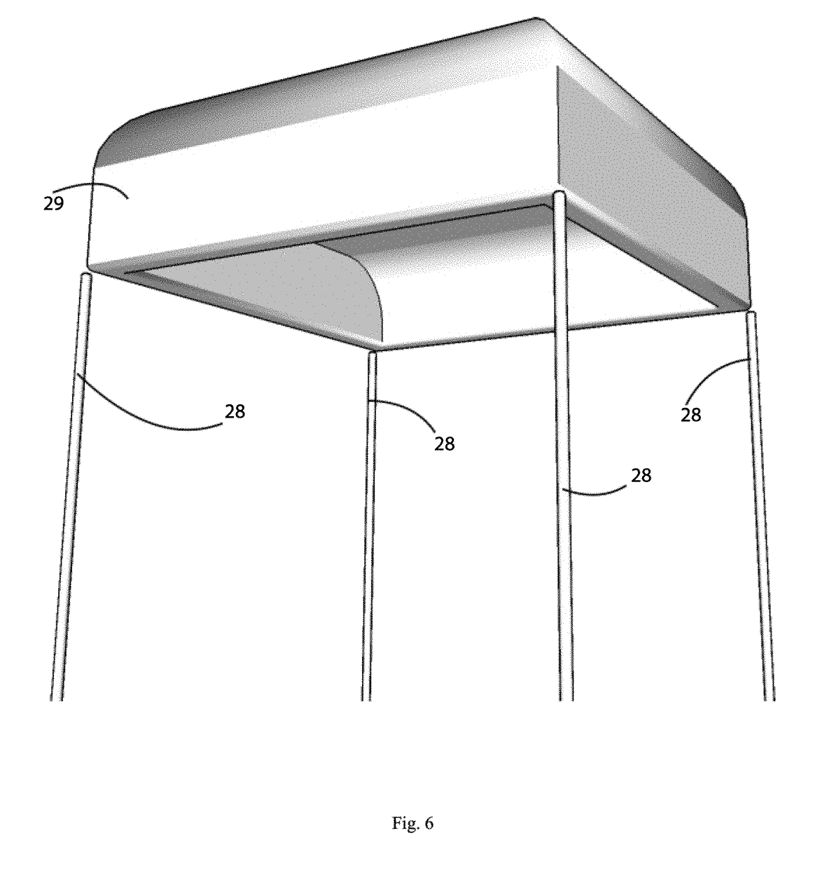

The buoyancy capture device 29 (FIG. 6) comprises a structure that captures free H2 and may provide tension to support the organization of the lower platform 2 and upper platform 17. In some embodiments, it is thought that examples of a buoyancy capture device 29 may include: a balloon, a barge, or a drone. In some embodiments, it is thought that if the buoyancy capture device 29 is absent then the OPS 1 may function without a buoyancy capture device 29. The buoyancy capture device 29 preferably comprises the alternative power means 30 and the OPS monitoring system 31.

An alternative power means 30 may be preferably positioned on top of the buoyancy capture device 29 and comprises an extra power source for the OPS 1. In some embodiments, it is thought that an example of alternative power means may include solar cells and the like.

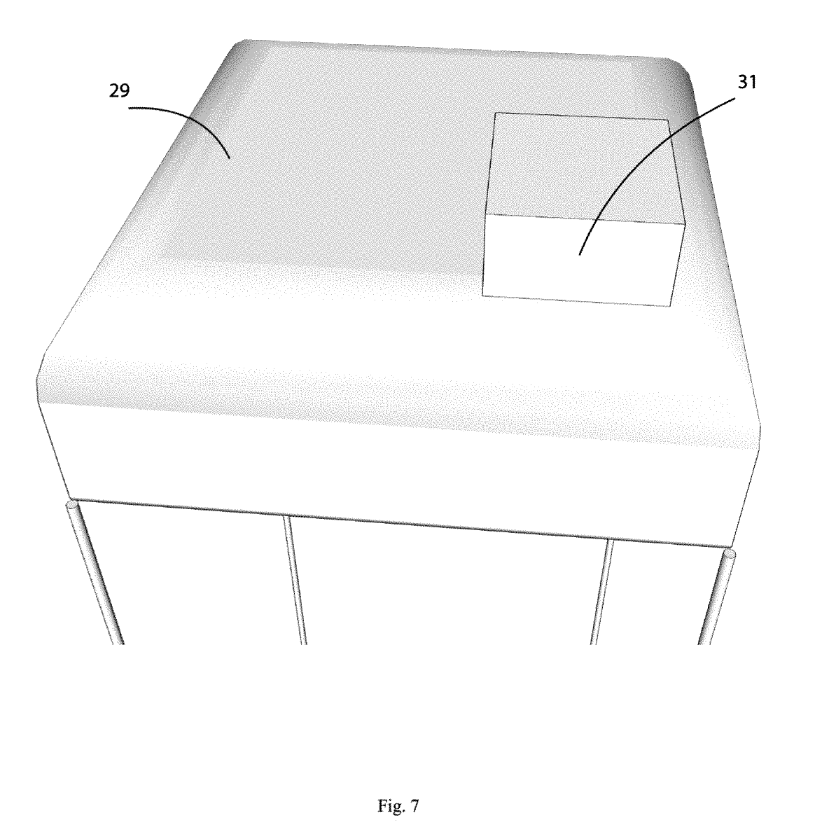

Further, an OPS monitoring system 31 (FIG. 7) may be present on the buoyancy capture device 29. It would comprise a system for remote monitoring and control of the OPS 1 and in turn comprise OPS monitoring system factors 32 and OPS monitoring system controls 33. OPS monitoring system factors 32 comprises variables and conditions monitored by the OPS monitoring system 31. In some embodiments, it is thought that examples of OPS monitoring system factors may include: water current, temperature, dissolved oxygen levels, cell operating conditions, voltage output, or O2 and H2 production. The OPS monitoring system controls 33 comprise functional routines implemented by the OPS monitoring system 31. In some embodiments, it is thought that examples of OPS monitoring system controls may include: a scheduled maintenance, trouble alarms, or system failures.

The buoyancy cables 28 (FIG. 6) comprises cables that operably connect from the buoyancy device to the upper platform to provide stability. In some embodiments, it is thought that if the buoyancy cables 28 is absent then can be anchored by a frame or have an alternative structure in order to be stable.

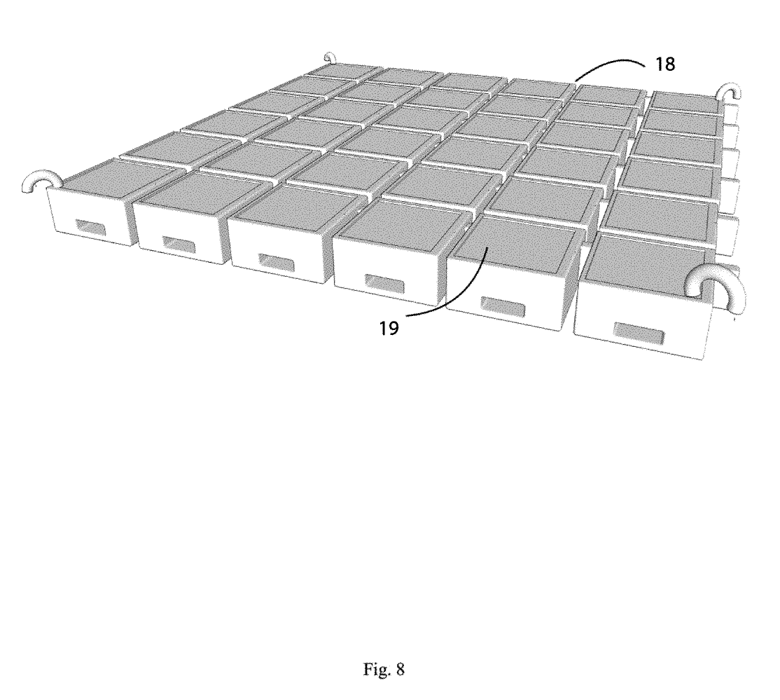

Spatially, the upper platform 17 (FIG. 8) is preferably positioned above the lower platform 2 and comprises an array of ec cell 19 that forms a stable structure for performing electrolytic reactions. The upper platform 17 preferably comprises the ec cell array 18.

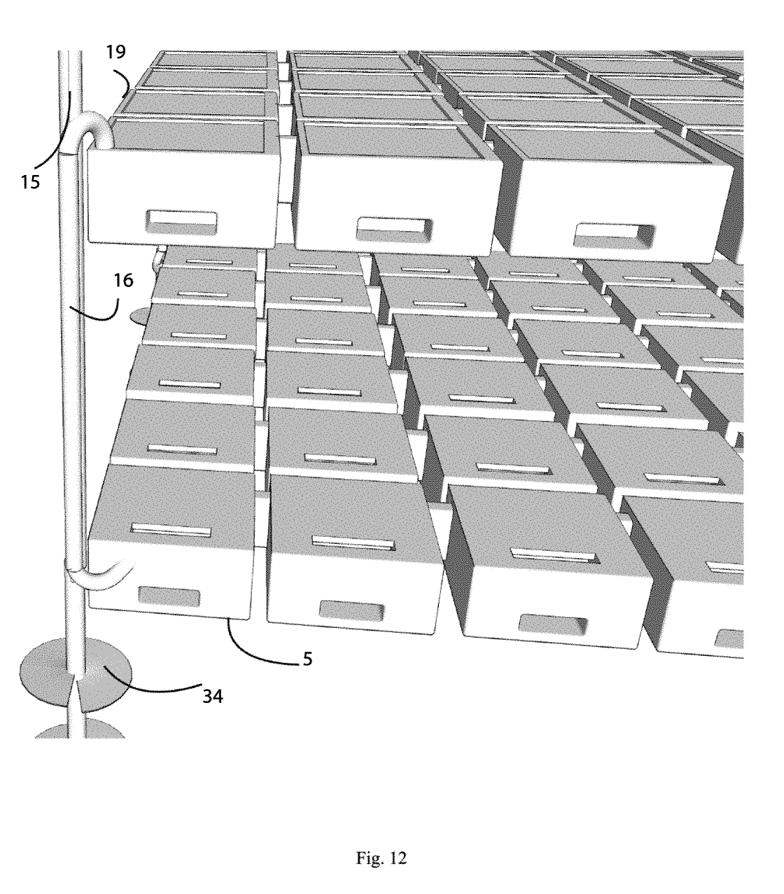

Connecting the upper and lower platform is the connection device 15, (FIG. 12) which is preferably positioned in between the lower platform 2 and the upper platform 17. The connection device 15 comprises a means for connecting the upper and lower platforms such as cables, frames, or structures. The connection device 15 preferably comprises the power transmission cables 16.

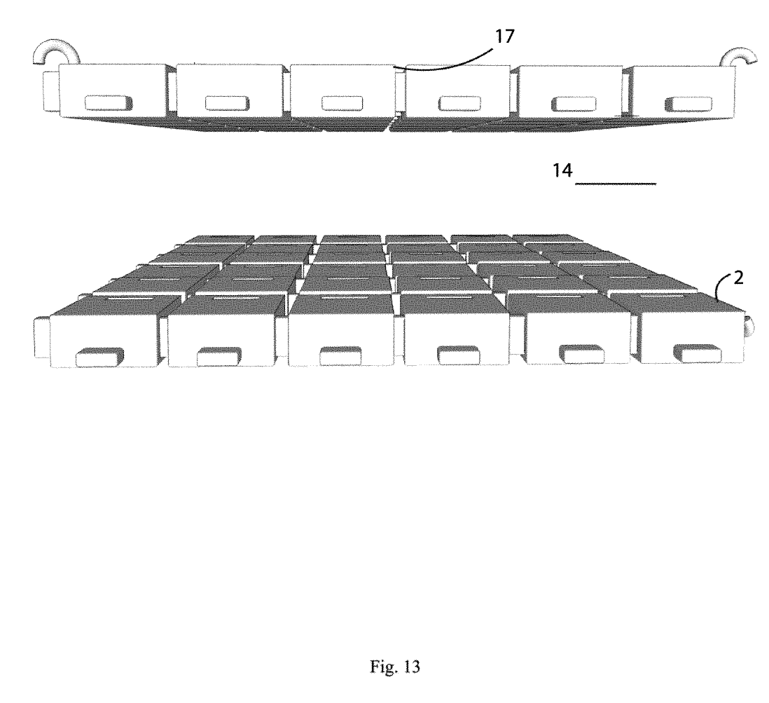

The distance between the upper and lower platform (FIG. 13) is important for the functionality and is herein termed the lower platform/upper platform distance 14. The lower platform/upper platform distance 14 has a preferred height of 24 inches and in some embodiments may also have a minimum of 24 inches. The lower platform/upper platform distance 14 comprises the minimum distance between the lower platform and the upper platform 17 that would allow the OPS 1 to be effective.

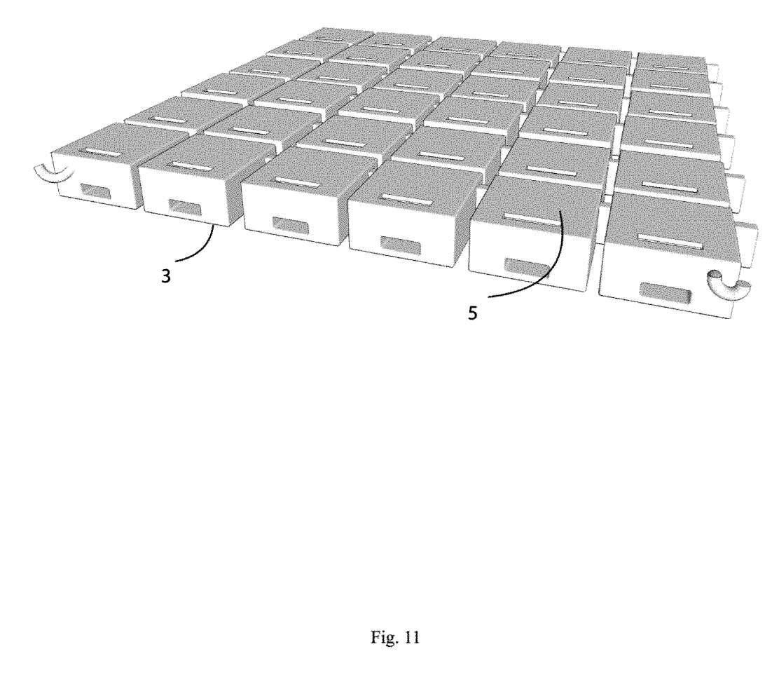

In turn, the lower platform 2 (FIG. 11) is preferably positioned below the upper platform. The lower platform 2 comprises an array of electrolytic cells that form a stable unit and comprises the e cell array 3.

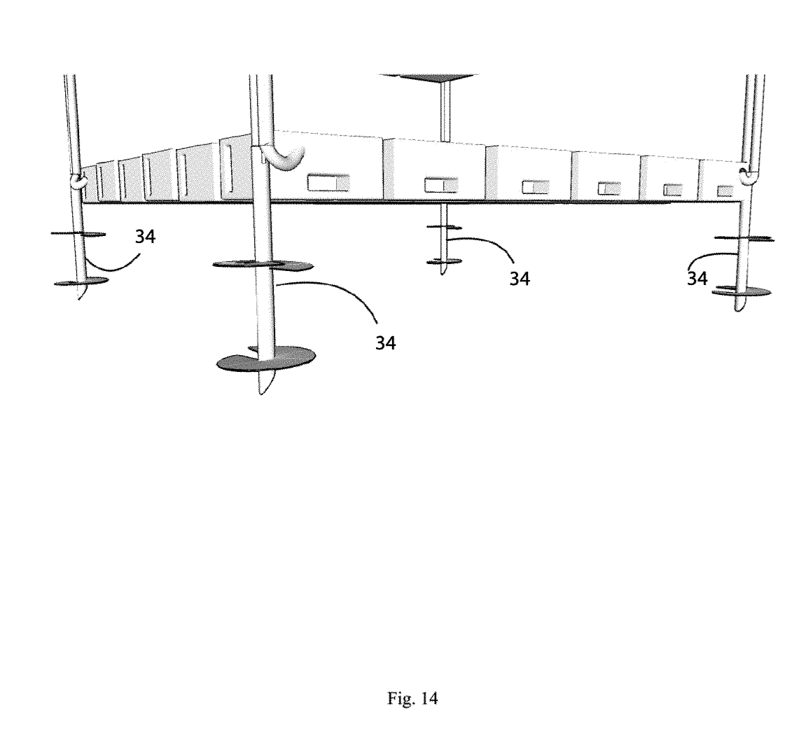

Stabilizing the structure, the OPS positioning system 34 (FIG. 14) comprises a system of providing maintenance of a specific geolocation and height with in the water column for the OPS. In some embodiments, it is thought that examples of an OPS positioning system may include: anchored cables, fixed platforms, a tower, a vertically moored tension leg and mini-tension leg platform, a spar-type, or a dynamic positioning system.

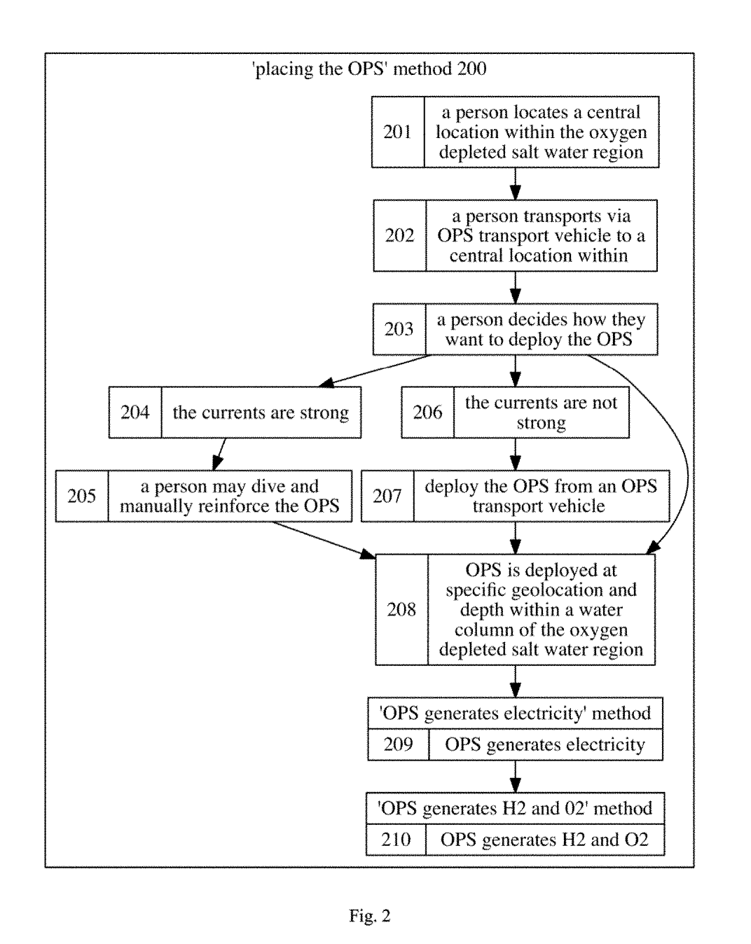

In order to use the system, a person locates one or more oxygen depleted salt water region 36 and transports the OPS 1 via an OPS transport vehicle 38 to a central location within (FIG. 2). An oxygen depleted salt water region 36 comprises a region of saline water that has low O2 concentration. In some embodiments, it is thought that examples of an oxygen depleted salt water region 36 may include: a gulf, a bait well, an ocean, a sea, or a lake. An OPS transport vehicle 38 comprises a vehicle that can deploy the OPS 1 to the oxygen depleted salt water region 36.

Next, depending on the environmental factors such as current, a person decides how they want to deploy the OPS 1. For example, if the currents are strong a person may dive and manually reinforce the OPS 1. If the currents are not strong, a person may deploy the OPS 1 from an OPS transport vehicle 38. This would result in the OPS 1 being deployed at a specific geolocation and depth within a water column of the oxygen depleted salt water region 36.

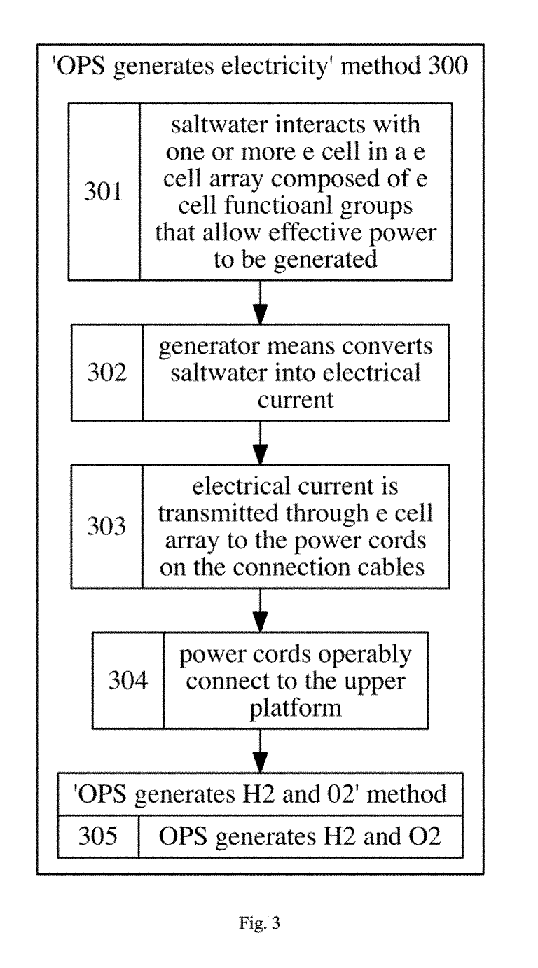

In order for the OPS 1 to generate electricity, saltwater interacts with one or more e cell in a e cell array 3 composed of e cell functional groups that allow effective power to be generated (FIG. 3). An e cell array 3 is preferably positioned within the lower platform 2 and comprises the array of functional groups that form the lower platform 2.

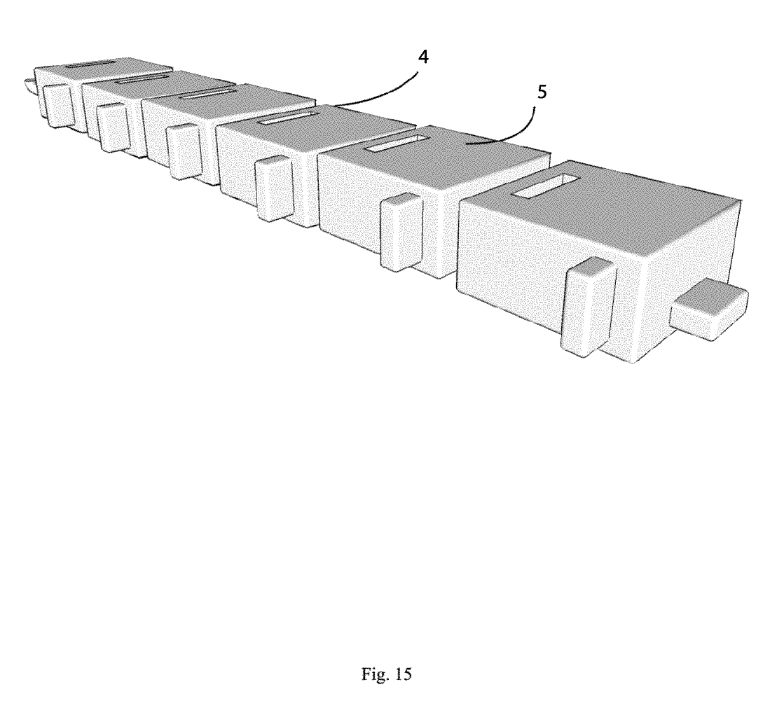

One goal of the e cell array 3 (FIG. 11) is to have the ability rapidly change the number of e cell 5 and size of the platform based on desired output or environmental conditions. The e cell array 3 preferably comprises an e cell functional group 4 (FIG. 15) which is the number of e cell 5 required to reach the minimum effective voltage. In turn, an e cell functional group 4 preferably comprises an e cell 5.

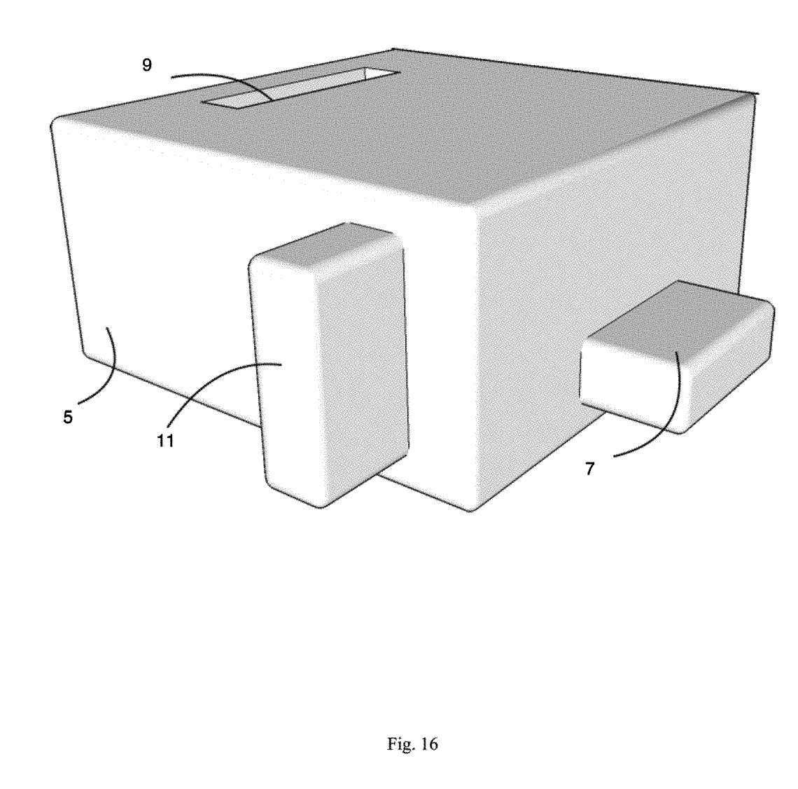

An e cell 5 (FIG. 16) is preferably positioned within the lower platform 2 and within an e cell functional group 4. The e cell 5 comprises electrolytic cells that generate electricity from seawater and allow interconnection of cells between each other in order to form a stable platform. The e cell 5 is preferably shaped like a square, however, it is thought that in alternative embodiments that it may also be shaped like a rectangle, a triangle, or octagonally.

The modularity of the e cell 5 allows for rapid structural expansion and easy replacement, in case off malfunction or damage. It has a voltage that is lower than minimum effective voltage 39 of the ec cell so that modularity of multiple e cells in a functional group, can adapt to variable electrical demands based on environmental conditions. The e cell 5 preferably comprises an e cell negative connection set 6, an e cell saltwater conduit 9, an e cell positive connection set 10, and finally an e cell energy generating means.

Thee cell energy generating means 13 are preferably located within the e cell 5. The e cell energy generating means 13 comprises a generator that creates electricity via electro-chemical means and uses local salt water as an electrolyte. This is done through an e cell saltwater conduit 9, which comprises one or more aperture on the e cell 5 that allows salt water to enter the cell.

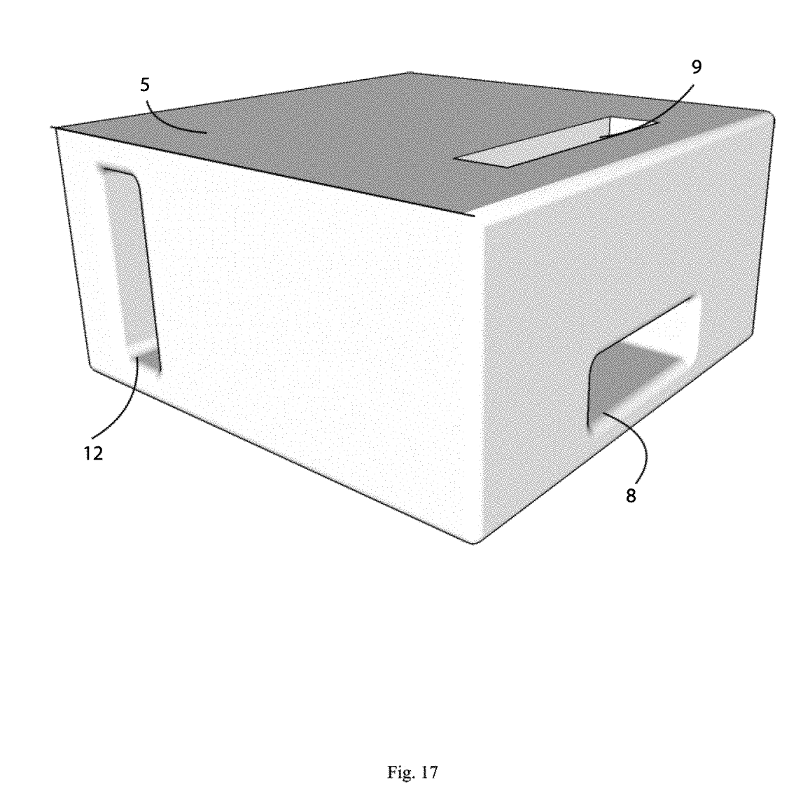

Adjacent e cells will have an e cell negative connection set 6 and positive connection set (FIGS. 16, 17). An e cell negative connection set 6 comprises a set of male and female components that allow structural configuration and transmit power. This is accomplished by an e cell negative connection insert 7 and the e cell negative connection receptor 8. The insert is preferably positioned extending from the e cell surface and the e cell negative connection receptor 8 is preferably positioned recessed from the e cell surface.

Similarly, adjacent e cells will have an e cell positive connection set 10 comprises a set of male and female components that allow structural configuration to transmit power (FIGS. 16, 17). This is accomplished by an e cell positive connection insert 11 and the e cell positive connection receptor 12. The insert is preferably positioned extending from the e cell surface and the e cell positive connection receptor 12 is preferably positioned recessed from the e cell surface.

When salt water enters the conduit and is converted to power, the electrical current is transmitted through the e cell array to the power transmission cables 16 on the connection device 15. The power transmission cables 16 then transmit the electricity to the ec cell array. Spatially, the power transmission cables 16 are preferably positioned in between the lower platform 2 and the upper platform 17 and adjacent to the connection device 15. They comprises the cables that operably deliver the electricity from the lower platform to the upper platform (FIG. 12).

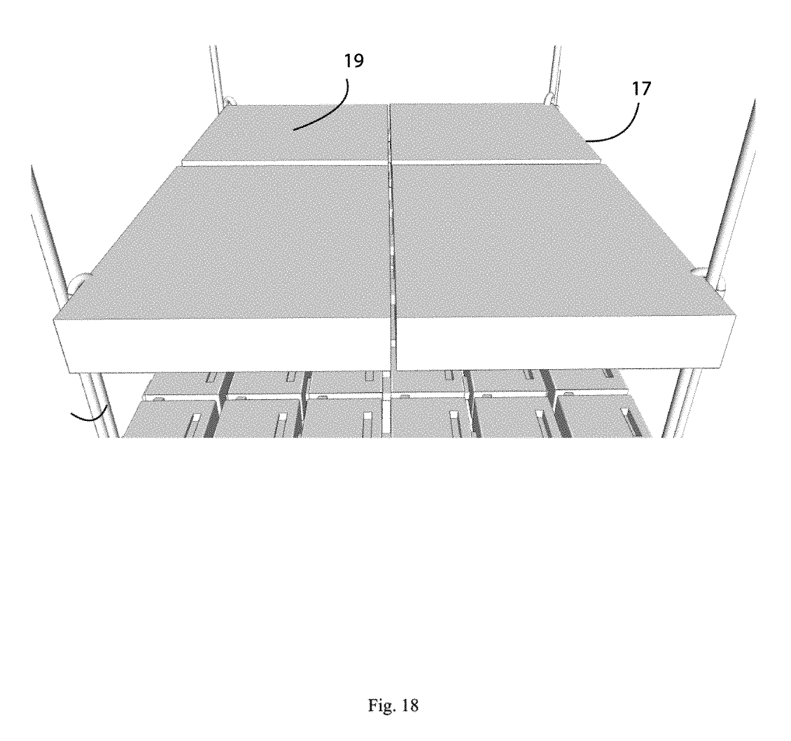

Spatially, the ec cell array 18 is preferably positioned within the upper platform 17. The ec cell array 18 comprises the number of ec cells that can be effectively powered by the e cell array 3. The ec cell array 18 functions to both 1) induce an electrolytic reaction with salt water and to 2) balance the power output from the e cell array 3. The ec cell array 18 preferably comprises one or more ec cell 19 and has an alternative embodiment herein termed the ‘variable size’ embodiment (FIG. 18). The ‘variable size’ embodiment is an embodiment where the ec cells individually may be larger (or smaller) than the e cells, such that e cell array 3 N maybe more or less than the ec cell array 18 below.

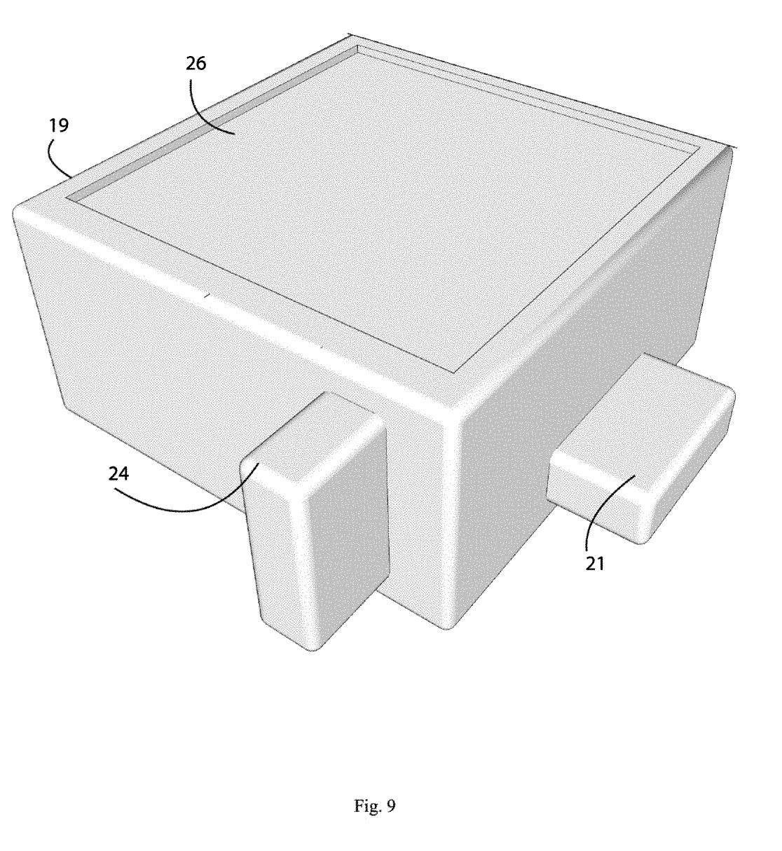

An ec cell 19 (FIG. 9) is preferably positioned within the ec cell array 18 (FIG. 8) and similar to the e cell, may be shaped like a square, rectangle, a triangle, or octagonally. An ec cell 19 comprises electrolytic cells that input salt water and output H2 and O2. The ec cell 19 preferably comprises an ec cell negative connection set 20, an ec cell positive connection set 23, an ec cell screen 26, and finally electrolytic reaction means.

An electrolytic reaction means 27 is preferably positioned within the ec cell and comprises one or more components of the ec cell that inputs saltwater and catalyzes the production of H2 and O2. The output of which filters through an ec cell screen 26 which is preferably positioned on the top of the ec cell 19 (though there may be other orientations). It comprises a screen through which microbubbles escape the ec cell.

Adjacent ec cells will have an ec cell negative connection set 20 and positive connection set (FIGS. 16, 17). An ec cell negative connection set 20 comprises a set of male and female components that allow structural configuration and transmit power. This is accomplished by an ec cell negative connection insert 21 and the ec cell negative connection receptor 22. The insert is preferably positioned extending from the ec cell surface and the ec cell negative connection receptor 22 is preferably positioned recessed from the ec cell surface.

Similarly, adjacent ec cells will have an ec cell positive connection set 23 comprises a set of male and female components that allow structural configuration to transmit power (FIGS. 16, 17). This is accomplished by an ec cell positive connection insert 24 and the ec cell positive connection receptor 25. The insert is preferably positioned extending from the ec cell surface and the ec cell positive connection receptor 25 is preferably positioned recessed from the ec cell surface.

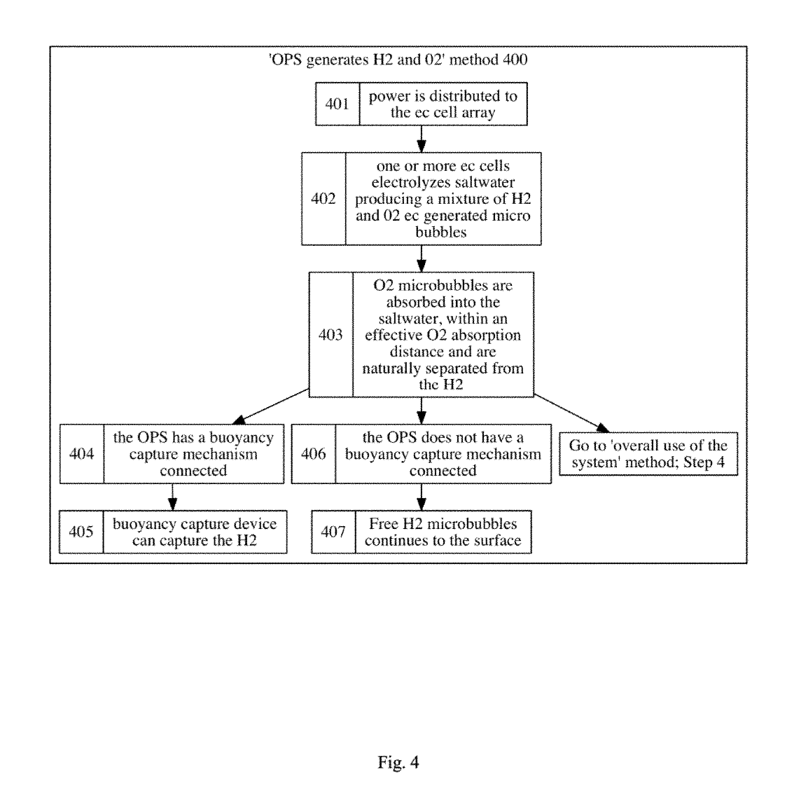

As power is drawn by an ec cell, one or more ec cells electrolyzes saltwater producing a mixture of H2 and O2 ec generated micro bubbles 35 (FIG. 4). As this mixture of micro bubbles rises, O2 microbubbles are absorbed into the saltwater, within an effective O2 absorption distance 37 and are naturally separated from the H2. The ec generated micro bubbles 35 comprises bubbles of H2 and O2 produced from an electrolytic reaction in salt water. Further, an effective O2 absorption distance 37 comprises the minimum distance between the upper platform and the surface in which O2 can be effectively absorbed.

If the OPS 1 has a buoyancy capture mechanism connected then the buoyancy capture device 29 can capture the H2. If the OPS 1 does not have a buoyancy capture mechanism connected then free H2 microbubbles will continue to the surface.

I claim:

1. a method for increasing dissolved oxygen levels in salt water comprising the steps of:
placing an oxygen system in a salt water column, wherein said oxygen system comprises an array of electrical generating cells and one or more electrolytic cells, wherein said electrical generating cells provide power for said electrolytic cells
observing an increase in dissolved O2 level in said salt water column.

2. a system for increasing dissolved oxygen levels in salt water comprising:
a lower platform comprised of an array of electrical generating cells, said lower platform separated from an upper platform of one or more electrolytic cells, one or more power transmission cables connecting said lower platform and said upper platform.
